(19) United States
(12) Patent Application Publication
(10) Pub. No.: US 2009/0180722 A1
(43) Pub. Date: Jul. 16, 2009

(54) LOAD SENSING WHEEL END

(75) Inventors: John D. Dougherty, Canton, OH (US); Graham McDearmon, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, Canton, OH (US)

(21) Appl. No.: 12/281,714

(22) PCT Filed: Mar. 6, 2007
(86) PCT No.: PCT/US07/63375

§ 371 Date: Sep. 4, 2008

Related U.S. Application Data
(60) Provisional application No. 60/779,576, filed on Mar. 6, 2006.

(51) Int. Cl. F16C 41/00

(52) U.S. Cl. 384/448

(57) ABSTRACT

A load sensing antifriction bearing (16) for a vehicle that senses wheel loads applied by a road wheel R to a suspension upright (10) of the vehicle. The load sensing antifriction bearing (16) supports a shaft connected to the road wheel R and provides an axis X of rotation about which the road wheel R can rotate. The load sensing antifriction bearing (16) comprises an outer race (36), the outer race further (36) having a flange (20) configured for attachment to the suspension upright (10). The flange (20) has a face (22) that is presented away from the suspension upright (10) and having a groove (24) opening out of that face (22). The bearing (16) also comprises an inner race (42). Rolling elements (48) are located between and contact the outer race (36) and the inner race (42). A sensor substrate (54) attaches to the flange (20) on each side of the groove (24) such that the sensor substrate (54) spans the groove (24). Additionally, a sensor (60) attaches to the sensor substrate (54) wherein the sensor measures substrate strains, caused by radial expansions and contractions of the groove and axial displacements across the groove (24), as the suspension upright (10) experiences applied loads.

### CROSS-REFERENCE TO RELATED APPLICATIONS

This application is the United States National Stage under 35 U.S.C. § 371 of International Application Serial No. PCT/US2007/0063275 having an International Filing Date of Mar. 6, 2007, and is related to and claims priority to U.S. Provisional Patent Application No. 60/779,576, filed on Mar. 6, 2006, the contents of which are incorporated herein by reference.

### TECHNICAL FIELD

This disclosure relates in general to monitoring road forces/loads applied to automotive vehicles. In particular, the present disclosure relates to monitoring and measuring loads applied to a suspension system of the vehicle.

### BACKGROUND ART

Automobiles and light trucks of current manufacture contain many components that are acquired in packaged form from outside suppliers. The packaged components reduce the time required to assemble automotive vehicles and further improve the quality of the vehicles by eliminating critical adjustments from the assembly line. Additionally, these package components are suitable for high volume production. So-called “wheel ends” represent one type of packaged component that has facilitated the assembly of vehicles.

A typical wheel end of the automotive vehicle has a housing that is bolted against a steering knuckle or other suspension upright of a suspension system. The typical wheel end also has a hub provided with a flange to which a road wheel is attached and also a spindle that projects from the flange into the housing. Additionally, the wheel end has an antifriction bearing located between the housing and the spindle to enable the hub to rotate in the housing with minimal friction. The bearing has the capacity to transfer radial loads between the hub and housing and also thrust loads in both axial directions.

The housing for the typical wheel end itself has a flange that bears against a component of the suspension system to which it is secured at three or four locations, normally with machine bolts that pass through the suspension system and thread into the flange. These bolts secure the entire wheel end to the suspension system. The suspension system may comprise a strut assembly, which transfers loads from a spring and damper combination to the housing.

Information about the applied loads of the road wheel from the road increases the ability of a vehicle control system to manage drive train power, braking, steering and suspension system components. In particular, the forces exerted on any wheel of the automotive vehicle, particularly on the front wheels, if known, can be employed to enhance safety. Electrical signals representing wheel force can provide electronic braking and power train controls with information about vehicle loading and road conditions, enabling those controls to conform the operation of the vehicle to best accommodate the forces.

It is often difficult for a driver to detect reduced level of friction of the vehicle's tires on a roadway surface caused by ice formation or hydroplaning until loss of control occurs. Early warning of such a dangerous condition would enhance safety. Measurement of the wheel end loads (radial, lateral, and longitudinal) and moments (overturning and steering) would be useful for vehicle stability control systems used to protect against vehicle roll over. By knowing the instantaneous loading condition at each wheel, the onset of potential roll over or spin out can be detected and prevented by engine throttling and/or brake application of selected wheel(s).

Current suspension load sensing devices are expensive and difficult to manufacture. The present disclosure provides a cost effective method of providing wheel force information suitable for high volume production.

### DESCRIPTION OF THE DRAWINGS

FIG. 1 is a longitudinal sectional view of a wheel end constructed in accordance with and embodying the present disclosure;

FIG. 2 is a perspective view of a housing flange of the wheel end of FIG. 1 illustrating a groove opening out of a face of the housing flange;

FIG. 3 is a front elevational view of the housing flange of FIG. 2 illustrating a sensor substrate positioned across the groove and a sensor associated with the sensor substrate;

FIG. 4 is a side elevational view of the housing flange of FIG. 3;

FIG. 5 is a front elevational view of the housing flange of FIG. 2 illustrating multiple sensor substrates positioned across the groove and sensors positioned on the sensor substrates;

FIG. 6 is longitudinal sectional view of another wheel end constructed in accordance with and embodying the present disclosure;

FIG. 7 is a perspective view of another housing flange of the wheel end of FIG. 2 illustrating a groove opening out of a face of the housing flange and illustrating another groove opening out of another face of the housing flange;

FIG. 8 is a back elevational view of the housing flange of FIG. 7; and

FIG. 9 is a front elevational view of the housing flange of FIG. 7 illustrating a sensor substrate positioned across the groove and a sensor positioned on the sensor substrate.

### DETAILED DESCRIPTION OF THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The present disclosure resides in a load sensing wheel end, with forces and moments being sensed across an annular groove formed in a face of a housing flange. The flange design facilitates force and moment sensing by adding one or more grooves that can be machined into the flange by a simple operation such as a lathe operation. The disclosure also eliminates any complex assembly methods needed to create the more complex structures heretofore considered for sensing loads at wheel ends.

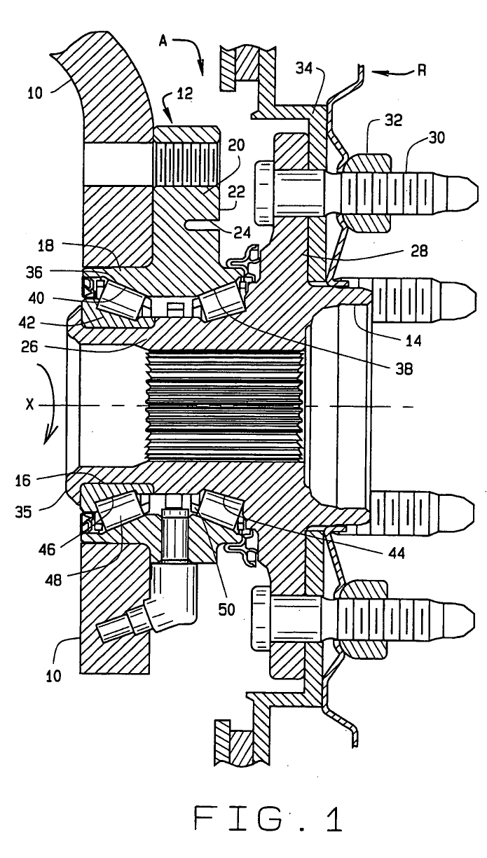

Referring to the drawings, a wheel end generally shown as A, which is in essence a bearing assembly, couples a road wheel R to a suspension system component such as a suspension upright generally shown as 10 of an automotive vehicle (FIG. 1). The wheel end A enables the road wheel to rotate about an axis “X” of rotation and to transfer both radial loads and thrust loads in both axial directions between the road wheel R and the suspension upright 10. If the road wheel R steers the vehicle, the suspension upright 10 takes the form of a steering knuckle. If the road wheel R does not steer the vehicle, the suspension upright 10 is a simple suspension system. The wheel end A includes a housing 12 that is bolted to the suspension upright 10, a hub 14 to which the road wheel R is attached, and an antifriction bearing 16 located between the housing 12 and hub 14 to enable the latter to rotate with respect to the former about the axis “X” of rotation with minimal friction. The load sensing antifriction bearing 16 senses wheel loads applied by the road wheel R to a suspension upright 10 of the vehicle. The load sensing antifriction bearing 16 supports a shaft (not shown) connected to the road wheel R and provides the axis “X” of rotation about which the road wheel R can rotate.

The housing 12 includes a generally cylindrical body 18, which is tubular, and a housing flange 20 that projects radially from the body 18. The inboard segment of the body 18 is received snugly in the suspension upright 10, wherein the wheel end A is attached to the suspension upright 10 at the flange of its housing 12. The housing flange 20 has a face 22 that is presented away from the suspension upright 10. As shown, the face 22 has a groove 24 opening out the face 22.

The hub 14 includes a spindle 26, which extends through the body 18 of the housing 12, and a hub flange 28 that is formed integral with the spindle 26 at the outboard end of the spindle 26. As shown the spindle 26 projects from the hub flange 28 and into the housing 12. The hub flange 28 is fitted with lug bolts 30 over which lug nuts 32 thread to secure a brake disk 34 and the road wheel R to the hub 14.

The spindle 26 merges with the hub flange 28 at an enlarged region that leads out to a cylindrical bearing seat that in turn forms a formed end 35. The formed end 35 is directed outwardly away from the axis “X” of rotation and provides an inside face that is squared off with respect to the axis “X” of rotation and is presented toward the enlarged region. Initially, the flange hub 28 does not have the formed end 35 at the inboard end of the spindle 26. Instead, the flange hub 28 is manufactured with a deformable end that forms the extension of the bearing seat. U.S. Pat. Nos. 6,443,622 and 6,532,666, which are incorporated herein by reference, disclose procedures for providing the formed end 35.

As shown in FIG. 1, the antifriction bearing 16 lies between the spindle 26 of the hub 14 and the housing 12. The antifriction bearing 16 is configured to transfer radial loads between the housing 12 and hub 14 and also thrust loads in both axial directions. The antifriction bearing 16 comprises an outer race 36 having first and second outer raceways 38, 40 presented inwardly toward the axis “X” of rotation. As shown, the outer race is part of the housing 12. The two tapered outer raceways 38 and 40 formed on the interior surface of the body 18 for the housing 12, the former being outboard and the latter being inboard. The two raceways 38 and 40 taper downwardly toward each other so that they have their least diameters where they are closest, generally midway between the ends of the housing 12.

The antifriction bearing 16 also comprises an inner race 42 having first and second inner raceways 44, 46 carried by the shaft, the first inner raceway 44 being presented toward the first outer raceway 38 and inclined in the same direction as that raceway 38, the second inner raceway 46 being presented toward the second outer raceway 40 and inclined in the same direction as that raceway 40. The inner raceway 44 lies at the outboard position and faces the outboard outer raceway 38, tapering in the same direction downwardly toward the center of the housing 12. The second inner raceway 46 presents outwardly toward the inboard outer raceway 40 on the housing 12 and tapers in the same direction, downwardly toward the middle of the housing 12.

Completing the bearing 16 are rolling elements in the form of tapered rollers 48 organized in two rows, one set located between and contacting the outboard raceways 38 and 44 and the other set located between and contacting the inboard raceways 40 and 46. The rollers 48 of each row are on an apex. The taper of the rollers 48 and raceways is such that there is pure rolling contact between the rollers 48 and the raceways 38, 40, 44 and 46. The rollers 48 of each row are separated by a cage 50 that maintains the proper spacing between the rollers 48 and further retains them in place around their respective raceways in the absence of the housing 12. The rollers 48 transmit thrust and radial loads between the raceways, while reducing friction to a minimum.

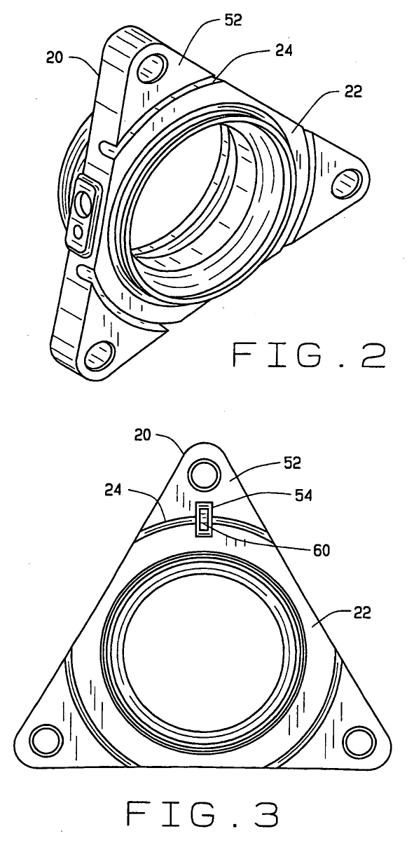

Referring to FIG. 2, the housing flange 20 is shown as triangular in shape, with tapped holes that are used to secure the housing flange 20 to the suspension upright using bolts. The housing flange 20 typically has lobes 52, with most having three lobes 52 that impart triangular configurations to such flanges. Normally a three-lobe flange is mounted with one of the lobes 52 at the top center position on the suspension upright 10. In an embodiment (not shown), the housing flange 20 has four lobes. The housing flange 20 is modified to position the groove 24 on the non-mounting face 22 of the housing flange 20. As shown, the groove 24 comprises an annular groove positioned within the face 22 of the housing flange 20. The groove geometry is determined uniquely for each application; such that, acceptable fatigue life is assured under worst case application loading conditions.

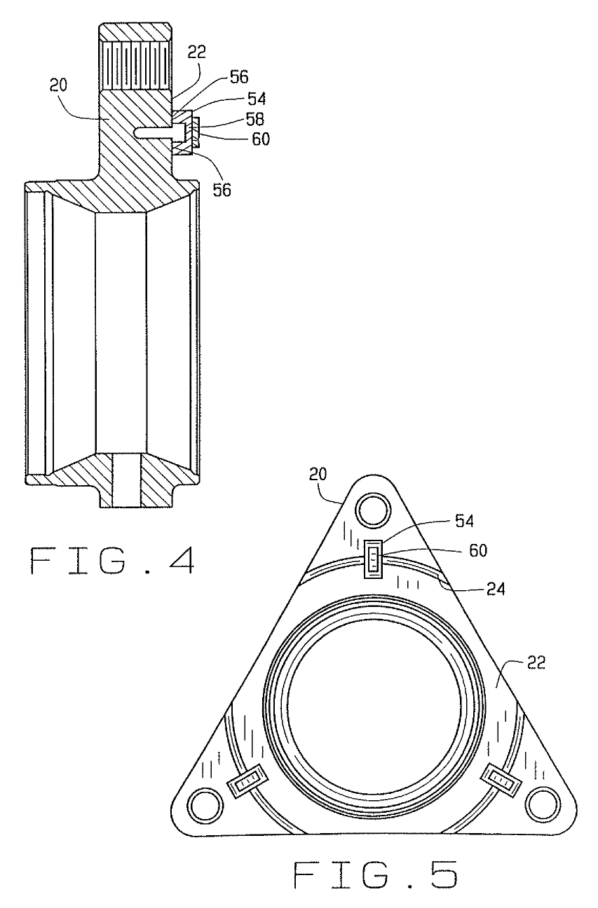

Turning to FIGS. 3 and 4, a sensor substrate 54 attaches to the housing flange 20. The sensor substrate 54 attaches to the housing flange 20 on each side of the groove 24 such that the sensor substrate 54 spans the groove 24. The sensor substrate 54 attaches to the housing flange 20 and spans the groove 24 on the outwardly presented face 22 of the housing flange 20, that is to say the face 22 that is on the non-mounting side of the housing flange 20. In an embodiment, the sensor substrate 54 is formed from stainless steel. The sensor substrate 54 includes two pads 56—there being a pad 56 on each side of the groove 24 in the housing flange 20. The pads 56 may be welded to the non-mounting face 22 of the housing flange 20. The sensor substrate 54 also includes a bridge 58 that is formed integral with the two pads 56 and actually spans the groove 24 that separates the pads 56, extending radially with respect to the axis “X” of rotation of the wheel end A. Accordingly, the sensor substrate 54 extends radially from the axis “X” of rotation as the sensor substrate 54 spans the groove 24.

As shown in FIGS. 3 and 4, a sensor 60 attaches to the sensor substrate 54. In an embodiment (not shown), the sensor 60 integrates within the sensor substrate 54. The sensor 60 measures both in-plane radial expansions and contractions of the groove 24 and out-of-plane axial displacements across the groove 24 as the suspension upright 10 experiences applied loads when the road wheel R traverses a surface 22. The sensor 60 measures radial strains of the sensor substrate 54 in real time as the groove 24 expands and contracts as well as axial relative displacements across the groove 24. In an embodiment, the sensor 60 positions on top of the sensor substrate 54, wherein the sensor 60 measures the strains at two locations on the sensor substrate 54 at a known distance apart while compensating for temperature differentials experienced by the groove 24. The sensor 60 measures the radial strains on the top surface of the sensor substrate 54 using strain devices, such as but not limited to, metal foil strain gages and micro-electro mechanical system (MEMS) sensors. In response, the sensor 60 produces electrical signals that reflect strains acting on the top surface of the bridge 58 to which the sensor 60 is attached. The sensor 60 communicates the measured strains to a vehicle control system to manage driving parameters such as drive train power, braking, steering and suspension system components.

With the single sensor substrate 54 and associated sensor 60, the sensor 60 measures the radial strains to obtain the overturning moment and lateral force experienced by the wheel end A. The overturning moment and lateral force are critical parameters required for an anti-rollover vehicle stability system. Preferably, the sensor substrate 54 and associated sensor 60 are positioned over the groove 24 at a top-dead-center position on the housing flange 20. Other positions of the sensor substrate 54 and sensor 60 on the groove 24, however, obtain the overturning moment and lateral force measurements.

Turning to FIG. 5, multiple sensor substrates 54 are positioned across the groove 24. In an embodiment, the sensor substrates 54 mount on the non-mounting face 22 of the housing flange 20 at three equally spaced locations. Further, as shown, sensors 60 attach to each of the sensor substrates 54 to measure the substrate strains caused by relative displacements at different locations of the groove 24 as the suspension upright 10 experiences applied loads while the road wheel R traverses the surface 22. As previously noted, the sensors 60 measure both in-plane radial expansions and contractions of the groove 24 and out-of-plane axial displacements across the groove 24 as the suspension upright 10 experiences applied loads when the road wheel R traverses a surface 22. The sensors 60 communicate the measured substrate strains to a vehicle control system to manage driving parameters such as drive train power, braking, steering and suspension system components.

With the multiple sensor substrates 54 and associated sensors 60, the sensors 60 measure the substrate strains to obtain the overturning moment and the steering moment and to obtain the radial forces, the lateral forces and the longitudinal forces experienced by the wheel end A. Preferably, the sensor substrates 54 and associated sensors 60 are positioned over the groove 24 at the three equally spaced illustrated positions. Other positions of the sensor substrates 54 and sensors 60 over the groove 24, however, obtain the overturning moment, the steering moment and radial, lateral and longitudinal forces.

Referring to FIG. 5, six radial strain readings are obtained by measuring the strains at two locations on the top surfaces of the three sensor substrates 54. These six strains can be combined, to estimate the three wheel end forces (radial, lateral, and longitudinal) and two moments (overturning and steering), by calibrating the design using known input forces and moments.

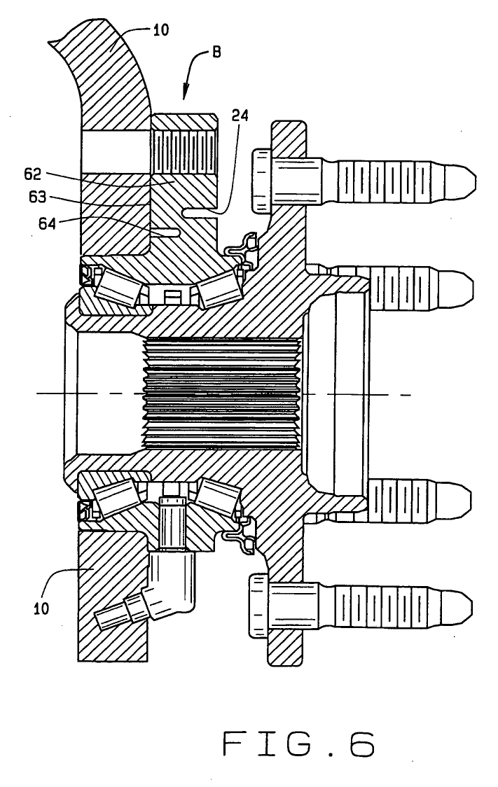

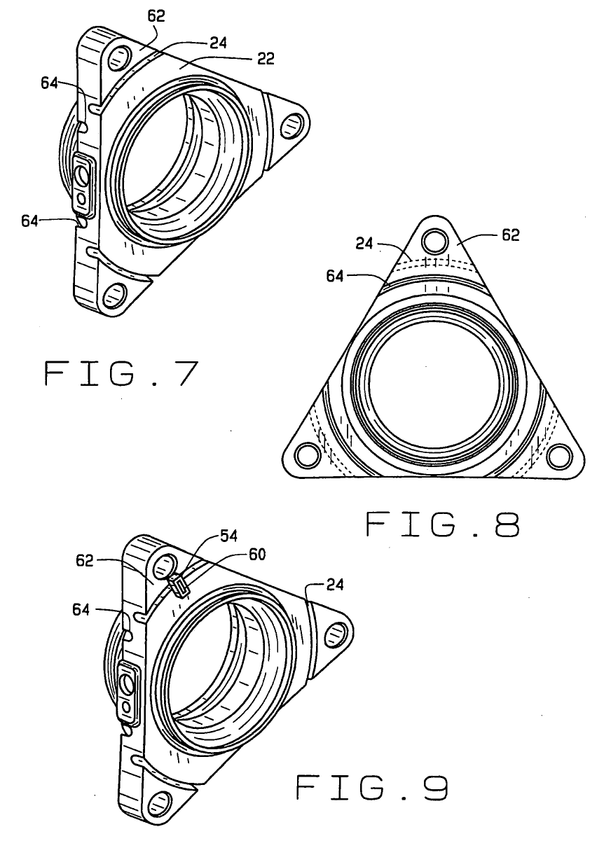

Referring to FIG. 6, another embodiment of a wheel end B is shown. In this embodiment, housing flange 62 has another face 63 that is presented toward the suspension upright 10. As shown, this other face 63 has another groove 64 opening out of the other face 63. Turning to FIGS. 7 and 8 and referring to FIG. 6, the other groove 64 is positioned at a lower radial position on housing flange 62 with respect to the groove 24 opening out of the face 22 that is presented away from the suspension upright. The other groove 64 positioned on face 63 adds compliance for more displacement experienced by the groove 24 located on the non-mounting face 22 of the housing flange 62.

As shown in FIG. 9, sensor substrate 54 spans groove 24 to position the sensor 60. The sensor 60 then measures the substrate strains, caused by radial expansions and contractions of the groove 24 and relative axial displacements across the groove 24, as the suspension upright 10 experiences applied loads while the road wheel R traverses the surface. In other embodiments, multiple sensor substrates 54 and associated sensors 60 may be positioned on face 22 of housing flange 62.

In the illustrated embodiments, the sensor substrate 54 mounts radially across the groove 24 on the non-mounting face of housing flange, so that one pad 56 of the sensor substrate 54 mounts radially below the annular groove 24 and the second pad 56 mounts radially above the annular groove 24. This mounting enables the sensor substrate 54 to be exposed to relative displacements across the groove 24, which can be measured by the strain sensor(s) 60 placed on the top of the sensor substrate 54.

During operation, a sum of the radial strains at two locations on the top surface of the sensor substrate 54 is proportional to the in-plane relative displacement across the groove 24, that is to say the displacement in a plane parallel to that face of the housing flange out of which the groove 24 opens. The difference in the radial strains, at two locations on the top surface of the sensor substrate 54, is proportional to the out-of-plane relative displacement across the groove 24.

In an embodiment, the sensor substrate 54 includes enlarged pads 56, to increase the surface area where it is welded or bonded to the housing flange 20, thus reducing the stresses along the interface. The sensor substrate 54 may include radial and/or axial slots put in to reduce the stresses at the interface, while maintaining the ability to measure radial strains along its top surface that are proportional to the in-plane and out-of-plane relative displacements across the groove 24.

Having load sensing bearings at all four road wheels would enable load shifting from side-to-side and front-to-back to be monitored and reacted to by the vehicle stability control system. Combining the wheel end load and moment data with brake force monitoring and torque monitoring would enable more robust vehicle control systems to be developed.

The antifriction bearing need not be a tapered roller bearing, but instead may be an angular contact ball bearing. Thus, the rolling elements instead of being tapered rollers would be balls. Actually, the bearing many be any type of antifriction bearing having raceways that enable it to transfer bother radial loads and axial loads. Additionally, the antifriction bearing and sensor has utility beyond vehicle control systems. Indeed, these components may be used in any housing that experiences, transfers or receives loads. Furthermore, those of ordinary skill in the art will recognize that any strain, displacement, rotation, or temperature sensor technology can be utilized within the scope of the present disclosure to acquire necessary measurements. For example, strain sensors such as, but not limited to, resistive, optical sensors, capacitive sensors, inductive sensors, piezoresistive, magnetostrictive, MEMS, vibrating wire, piezoelectric, and acoustic sensors are suitable and may be used within the scope of the invention.

As various changes could be made in the above constructions without departing from the scope of the invention, it is intended that all matter contained in the above description or shown in the accompanying drawings shall be interpreted as illustrative and not in a limiting sense.

1. A wheel end that attaches to a suspension upright of a vehicle, the wheel end comprising:
a housing having a housing flange configured for attachment to the suspension upright, the housing flange having a face that is presented away from the suspension upright and having a groove opening out of that face;
a hub having a hub flange configured for securement to a road wheel of the vehicle, the hub also having a spindle that projects from the hub flange and into the housing;
an antifriction bearing located between the housing flange and the spindle to enable the spindle to rotate about an axis, the antifriction bearing being configured to transfer radial loads between the housing and hub and also thrust loads in both axial directions;
a sensor substrate attached to the housing flange on each side of the groove such that the sensor substrate spans the groove; and
a sensor attached to the sensor substrate wherein the sensor measures substrate strains, caused by radial expansions and contractions of the groove and axial displacements across the groove, as the suspension upright experiences applied loads when the road wheel traverses a surface.

2. The wheel end of claim 1 wherein the groove comprises an annular groove positioned within the face of the housing flange.

3. The wheel end of claim 1 wherein the housing flange has another face that is presented toward the suspension upright such that the other face has another groove opening out of the other face.

4. The wheel end of claim 3 wherein the other groove is positioned at a lower radial position on the housing flange with respect to the groove opening out of the face that is presented away from the suspension upright.

5. The wheel end of claim 1 wherein the sensor measures the strains acting on a top surface of the sensor substrate in real time.

6. The wheel end of claim 1 wherein the sensor is a micro-electro mechanical system sensor.

7. The wheel end of claim 1 wherein the sensor substrate extends radially from the axis as the sensor substrate spans the groove.

8. The wheel end of claim 7 wherein a sum of radial strains as measured by the sensor at two locations on the sensor substrate is proportional to an in-plane displacement across the groove.

9. The wheel end of claim 7 wherein a difference of radial strains as measured by the sensor at two locations on the sensor substrate is proportional to an out-of-plane displacement across the groove.

10. The wheel end of claim 1 wherein the sensor substrate includes at least one radial slot, which is configured to reduce stress at an interface of the sensor substrate and the housing flange.

11. The wheel end of claim 1 wherein the sensor substrate includes at least one axial slot, which is configured to reduce stress at an interface of the sensor substrate and the housing flange.

12. A load sensing antifriction bearing for a vehicle that senses wheel loads applied by a road wheel to a suspension upright of the vehicle, the load sensing antifriction bearing supporting a shaft connected to the road wheel and providing an axis of rotation about which the road wheel can rotate, the load sensing antifriction bearing comprising:
an outer race having first and second outer raceways presented inwardly toward the axis of rotation, the outer race further having a flange configured for attachment to the suspension upright, the flange having a face that is presented away from the suspension upright and having a groove opening out of that face;
an inner race having first and second inner raceways carried by the shaft, the first inner raceway being presented toward the first outer raceway and inclined in the same direction as that raceway, the second inner raceway being presented toward the second outer raceway and inclined in the same direction as that raceway;
rolling elements located between and contacting the outer raceways and the inner raceways;
a sensor substrate attached to the flange on each side of the groove such that the sensor substrate spans the groove; and
a sensor attached to the sensor substrate wherein the sensor measures substrate strains, caused by radial expansions and contractions of the groove and axial displacements across the groove, as the suspension upright experiences applied loads.

13. The wheel end of claim 12 wherein the flange of the outer race has another face that is presented toward the suspension upright such that the other face has another groove opening out of the other face.

14. The wheel end of claim 13 wherein the other groove is positioned at a lower radial position on the flange with respect to the groove opening out of the face that is presented away from the suspension upright.

15. The wheel end of claim 12 wherein a sum of strains as measured by the sensor at two locations on the sensor substrate is proportional to an in-plane displacement across the groove.

16. The wheel end of claim 12 wherein a difference of strains as measured by the sensor at two locations on the sensor substrate is proportional to an out-of-plane displacement across the groove.

17. A suspension system for a vehicle, comprising:
a suspension upright operatively connected with a road wheel of the vehicle,
a housing having a housing flange configured for attachment to the suspension upright, the flange having a face that is presented away from the suspension upright and having a groove opening out of that face;
a hub having a hub flange configured for securement to the road wheel, the hub also having a spindle that projects from the hub flange;
an antifriction bearing located between the housing and the spindle to enable the hub to rotate about an axis of rotation, the antifriction bearing being configured to transfer radial loads between the housing and hub and also thrust loads in both axial directions;
a sensor substrate attached to the housing flange on each side of the groove and spanning the groove; and
a sensor attached to the sensor substrate wherein the sensor measures substrate strains, caused by radial expansions and contractions of the groove and axial displacements across the groove, as the suspension system experiences applied loads when the road wheel traverses a surface.

18. A method of monitoring the condition of a surface, the method comprising:
driving over the surface in a vehicle having road wheels connected to a suspension system of the automotive vehicle,
transferring wheel contact loads of the road wheels from the suspension system to an antifriction bearing of the vehicle; and
sensing strain loads of the antifriction bearing.

19. The method of claim 18 wherein sensing loads of the antifriction bearing comprises spanning a sensor substrate across a groove of the antifriction bearing wherein the sensor substrate includes a strain sensor.

20. The method of claim 19 wherein sensing loads of the antifriction bearing comprises measuring strains, caused by radial expansions and contractions of the groove and axial displacements across the groove, of the antifriction bearing.
